(19) United States
(12) Patent Application Publication
(10) Pub. No.: US 2010/0301118 A1
(43) Pub. Date: Dec. 2, 2010

(54) ANTENNA FOR RFID READER

(75) Inventor: Mark DURON, Patchogue, NY (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Schaumburg, IL (US)

(21) Appl. No.: 12/473,642

(22) Filed: May 28, 2009

(51) Int. Cl. G06K 7/00; H01Q 21/26

(52) U.S. Cl. 235/439; 343/797; 340/10.1

(57) ABSTRACT

An antenna for using within an allocated bandwidth having a nominal center frequency includes a support member, a first antenna structure, and a second antenna structure. The first antenna structure has a return loss maximized at a first optimal frequency. The second antenna structure has a return loss maximized at a second optimal. The difference between the first optimal frequency and the second optimal frequency is more than 10% of the allocated bandwidth but less than 100% of the allocated bandwidth.

### FIELD OF THE DISCLOSURE

The present disclosure relates generally to RFID technology.

### BACKGROUND

Radio Frequency Identification (RFID) technology is one kind of Automatic Identification and Data Capture technologies. RFID technology generally involves interrogating an RFID tag with radio frequency (RF) waves and reading the responding RF waves with a RFID reader. A RFID tag typically includes a miniscule microchip coupled to an RF antenna. RFID tags can be attached to the object to be identified. An RFID reader typically includes an antenna coupled to a transmitter and a receiver.

FIG. 1A shows a part of a simplified RFID reader 100 in one specific kind of implementation. In FIG. 1A, the RFID reader 100 includes an antenna 90 coupled to a transmitter 80 and a low noise amplifier 60. The RFID reader 100 also includes a three-port circulator 50, a demodulator 70, and a frequency generator 40. The transmitter 80 can include a power amplifier (PA), and the frequency generator 40 can include a phase-licked-loop (PLL). The three-port circulator 50 includes a port 51, a port 52, and a port 53.

In operation, the transmitter 80 generates an RF interrogation signal. This RF interrogation signal is coupled to the antenna 90 through the three-port circulator 50. The electromatic waves radiated from the antenna 90 are then received by the antenna in an RFID tag. In response to the interrogation from the RFID reader 100, the RF tag will reflect responding electromagnetic waves coded with the identification information of the RF tag. The responding electromatic waves are picked up by the antenna 90 as a responding RF signal. The responding RF signal enters the port 52, leaves the port 53, and is received by the low noise amplifier 60. The RF signal received by the low noise amplifier 60, after amplification, is demodulated with demodulator 70 that receives a reference RF signal from the frequency generator 40. The demodulated signals from the demodulator 70 are coupled to certain signal processing circuit to decode from the demodulated signals the identification information returned by the RF tag.

In an ideal situation, the low noise amplifier 60 should only receive the responding RF signal generated by the RF tag that is coupled from the port 52 to the port 53. In reality, however, the low noise amplifier 60 also receives other RF signals generated from other sources or propagation paths. For example, those RF interrogation signal transmitted to the port 52 form the port 51 can be reflected back from the antenna 90, enter the port 52 and be coupled to the port 53. To improve the signal quality of the responding RF signal generated by the RF tag as received by the low noise amplifier 60, it is desirable to minimize the RF signal reflected back from the antenna 90.

For given amount of RF signal sending to the antenna 90, the amount of RF signal reflected back from the antenna 90 can be characterized with a reflection coefficient. The reflection coefficient generally is a complex number with the magnitude less than one. The magnitude of this reflection coefficient can be considered as the return loss (or, more accurately the amplitude return loss in contrast to the power return loss). As shown in FIG. 1B, the return loss generally is a function of the frequency of the RF signal sending to the antenna 90. In many RFID reading systems, the return loss has the lowest value at certain optimal frequency, which usually is close to a nominal center frequency f₀ of the RFID reading systems.

In practical applications, the frequency of the RF signal sending to the antenna 90 is not always near the nominal center frequency f₀. Moreover, the frequency of the RF signal may constantly hop within certain allocated spectrum for RFID applications. For example, in FIG. 1B, the frequency of the RF signal can be higher than certain minimal frequency fₘᵢₙ but lower than certain maximum frequency fₘₐₓ. Within this bandwidth as specified by frequencies fₘᵢₙ and fₘₐₓ, the return loss can be significantly lower than the highest value at the optimal frequency. The lower value of the return loss will degrade the quality of the signal as received by the low noise amplifier 60. The lower value of the return loss can decrease the interrogation range of an RFID reading system. For a lower value of the return loss, while it may be possible to increase the interrogation range of the RFID reading system by increasing the power of the interrogation RF signal, such a solution usually decreases the battery time of the RFID reading system.

It is desirable to increase the return loss of the antenna of an RFID reading system over an allocated bandwidth.

### SUMMARY

In one aspect, the invention is directed to an antenna for using within an allocated bandwidth having a nominal center frequency. The antenna includes a support member, a first antenna structure, and a second antenna structure. The first antenna structure on the support member is for emitting and receiving electromagnetic waves primarily in a first polarization. The second antenna structure on the support member is for emitting and receiving electromagnetic waves primarily in a second polarization that is orthogonal to the first polarization. The first antenna structure has a return loss maximized at a first optimal frequency. The second antenna structure has a return loss maximized at a second optimal frequency. The difference between the first optimal frequency and the second optimal frequency is more than 10% of the allocated bandwidth but less than 100% of the allocated bandwidth.

In another aspect, the invention is directed to a method of generating electromagnetic waves by an RFID reader using channel frequencies within an allocated bandwidth having a nominal center frequency. The method includes generating with a first antenna structure in the RFID reader electromagnetic waves primarily in a first polarization at channel frequencies higher than the nominal center frequency. The first antenna structure has a return loss maximized at a first optimal frequency that is higher than the nominal center frequency. The method also includes generating with a second antenna structure in the RFID reader electromagnetic waves primarily in a second polarization at channel frequencies lower than the nominal center frequency. The second polarization is orthogonal to the first polarization. The second antenna structure has a return loss maximized at a second optimal frequency that is lower than the nominal center frequency.

Implementations of the invention can include one or more of the following advantages. The return loss for an antenna can be statistically improved over an allocated bandwidth for RFID applications. Such improvement of the return loss for the antenna can increase the interrogation range of an RFID reading system. Such improvement can also increase the battery time of an RFID reading system. These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1A shows a part of a simplified RFID reader in one specific kind of implementation.

FIG. 1B shows the return loss of an antenna as a function of the frequency of the RF signal applied to the antenna.

FIG. 2A-FIG. 2C are schematic of an antenna for an RFID reader in accordance with some embodiments.

FIG. 3 shows the return loss of the antenna in FIG. 2A as a function of the frequency of the RF signal applied to the antenna.

FIG. 4A and FIG. 4B are flowcharts of methods for generating RF electromagnetic waves with the antenna as shown in FIG. 2A-2C in accordance with some embodiments.

FIG. 4C shows the effective return loss of the antenna when the electromagnetic waves are generated with the methods as shown in FIG. 4A and FIG. 4B.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

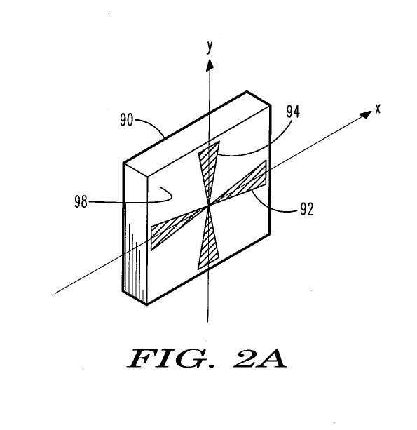

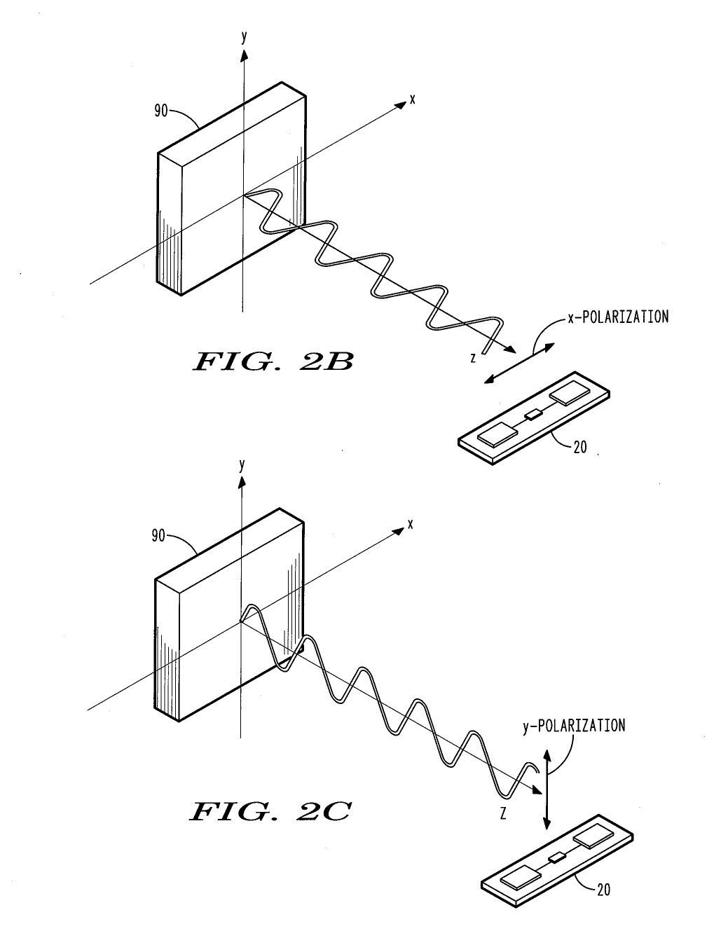

FIG. 2A is a schematic of the antenna 90 in accordance with some embodiments. The RFID antenna 90 includes a first antenna structure 92 and a second antenna structure 94 deposited on a support member 98. In some implementations, the first antenna structure 92 can form a dipole antenna, and the second antenna structure 94 can form a dipole antenna as well. As shown in FIG. 2B, when an RF power is applied to the first antenna structure 92, and RF waves with x-polarization can be generated. As shown in FIG. 2C, when an RF power is applied to the second antenna structure 94, and RF waves with y-polarization can be generated.

When the antenna 90 operates in a linear polarization mode, the antenna 90 may not be effective for interrogating RFID tags with certain polarizations. In FIG. 2B, when the antenna 90 generates the interrogating RF waves with the x-polarization, generally, some of these x-polarized RF waves can be efficiently coupled to the antenna of an RFID tag 20 with the x-polarization. In FIG. 2C, when the antenna 90 generates the interrogating RF waves with the y-polarization, generally, it can be difficult for these y-polarized RF waves to be efficiently coupled to the antenna of an RFID tag 20 with the x-polarization.

The antenna 90 can also operate in a cross-pole mode, in which the RF power is alternatively applied to the first antenna structure 92 and the second antenna structure 94. In the cross-pole mode, the antenna 90 generates RF waves with x-polarization during some time period, but generates RF waves with y-polarization during some other time period. When the antenna 90 operates in the cross-pole mode, RFID tags with any orientation in the x-y plane may possibly be interrogated.

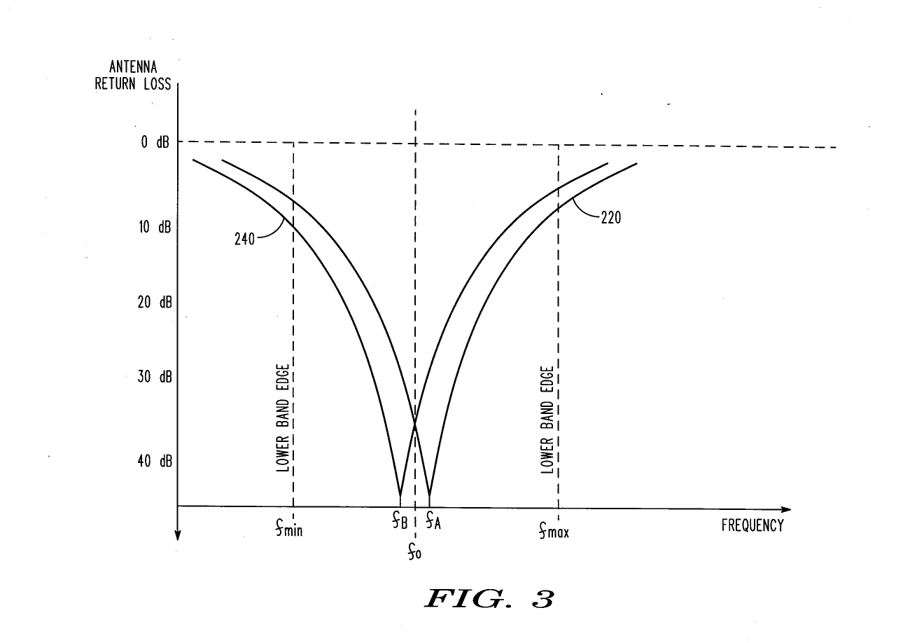

FIG. 3 shows the return loss of the antenna in FIG. 2A as a function of the frequency of the RF signal applied to the antenna. The return loss of the first antenna structure 92 is shown as curve 220. The return loss of the second antenna structure 94 is shown as curve 240. The return loss of the first antenna structure 92 is maximized at a first optimal frequency f_{A}. The return loss of the second antenna structure 94 is maximized at a second optimal frequency f_{B}.

In one implementation, when an antenna is to be used within an allocated bandwidth as characterized by a minimal frequency fₘᵢₙ and a maximum frequency fₘₐₓ, both the first optimal frequency f_{A} and the second optimal frequency f_{B} are preferably located within this bandwidth. In addition, the difference between the first optimal frequency and the second optimal frequency, f_{B}-f_{A}, preferably, should be more than 10% of the allocated bandwidth fₘₐₓ-fₘᵢₙ but less than 90% of the allocated bandwidth fₘₐₓ-fₘᵢₙ.

In FIG. 3, the first optimal frequency f_{A} is higher than the nominal center frequency f₀, and the second optimal frequency f_{B} is lower than the nominal center frequency f₀ In some implementations, the nominal center frequency f₀ can be approximately the same as the center frequency of the allocated bandwidth, that is, f₀≈(fₘₐₓ+fₘᵢₙ)/2. In other implementations, the nominal center frequency f₀ can be different the center frequency of the allocated bandwidth, that is, f₀≠(fₘₐₓ+fₘᵢₙ)/2.

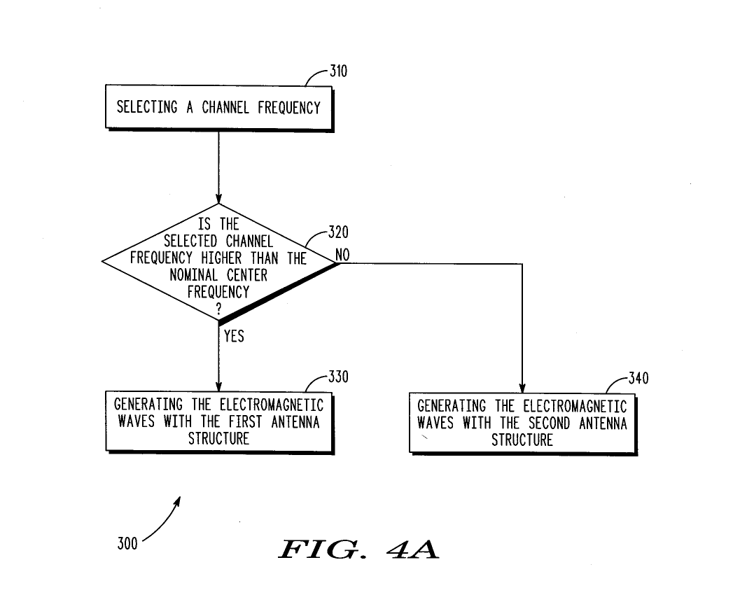

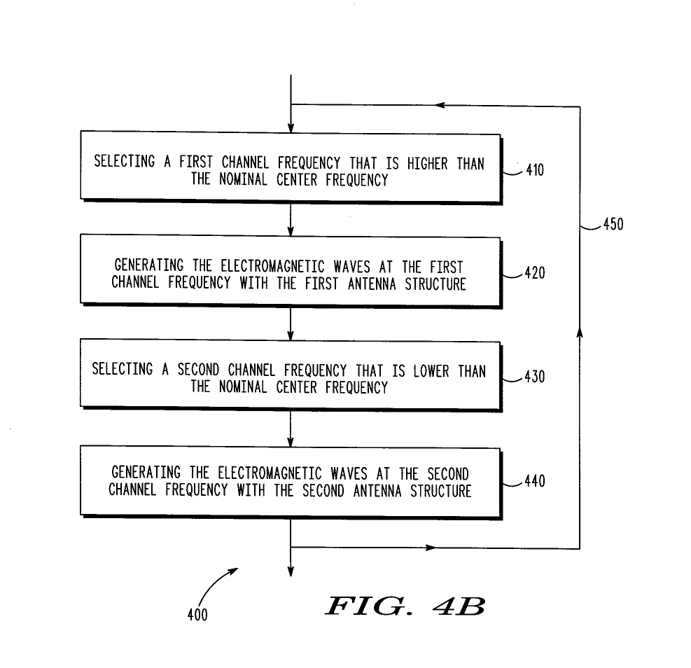

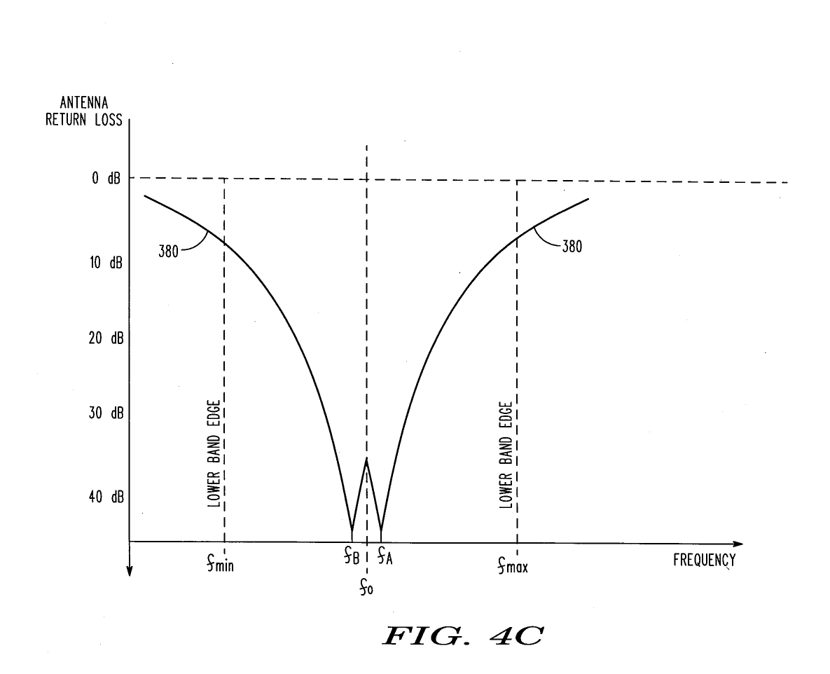

FIG. 4A shows a method 300 of generating RF electromagnetic waves with the antenna 90 as shown in FIG. 2A-2C which has a return loss as a function of the frequency as shown in FIG. 3. In FIG. 4A, the method 300 includes blocks 310, 320, 330, and 340. At block 310, the RFID reader selects a channel frequency from multiple channel frequencies within an allocated bandwidth. Next, at block 320, the RFID reader compares the selected channel frequency with the nominal center frequency. If the selected channel frequency is higher than the nominal center frequency, at block 330, the RFID reader generates the electromagnetic waves with the first antenna structure 92. If the selected channel frequency is lower than the nominal center frequency, at block 340, the RFID reader generates the electromagnetic waves with the second antenna structure 94.

One of the advantages of the method 300 is that it can improve the overall return loss of the antenna 90 within the allocated bandwidth fₘₐₓ-fₘᵢₙ, as compared with the return loss of either the first antenna structure 92 or the second antenna structure 94. As shown in FIG. 4C, when the electromagnetic waves are generated by the antenna 90 with the method 300, the effective return loss of the antenna 90 can be characterized by curve 380, which is overall better than the return loss as characterized by either the curve 220 or the curve 240 in FIG. 3.

FIG. 4B shows a method 400 of generating RF electromagnetic waves with the antenna 90 as shown in FIG. 2A-2C. In FIG. 4B, the method 400 includes blocks 410, 420, 430, and 440. At block 410, the RFID reader selects a first channel frequency that is higher than the nominal center frequency. Next, at block 420, the RFID reader generates the electromagnetic waves at the first channel frequency with the first antenna structure 92. Then, at block 430, the RFID reader selects a second channel frequency that is lower than the nominal center frequency. Thereafter, at block 440, the RFID reader generates the electromagnetic waves at the second channel frequency with the second antenna structure 94. Following flowchart path 450, the RFID reader repeats the actions as shown in blocks 410, 420, 430, and 440 sequentially.

Preferably, in each iteration of the blocks 410, 420, 430, and 440, the first channel frequency and the second channel frequency selected are different. For example, the first channel frequency and the second channel frequency may hop between multiple channel frequencies within some predetermined bandwidth allocated for the RFID reader. In one implementation, the first channel frequency and the second channel frequency can be offset from the nominal center frequency by a same amount so that the frequencies used by the RFID reader will be distributed symmetrically around the nominal center frequency.

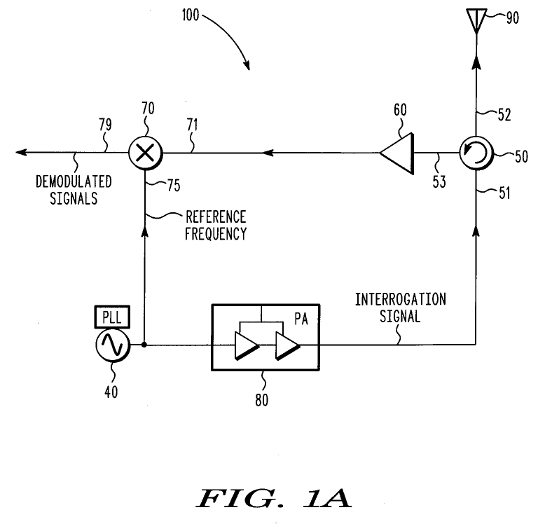

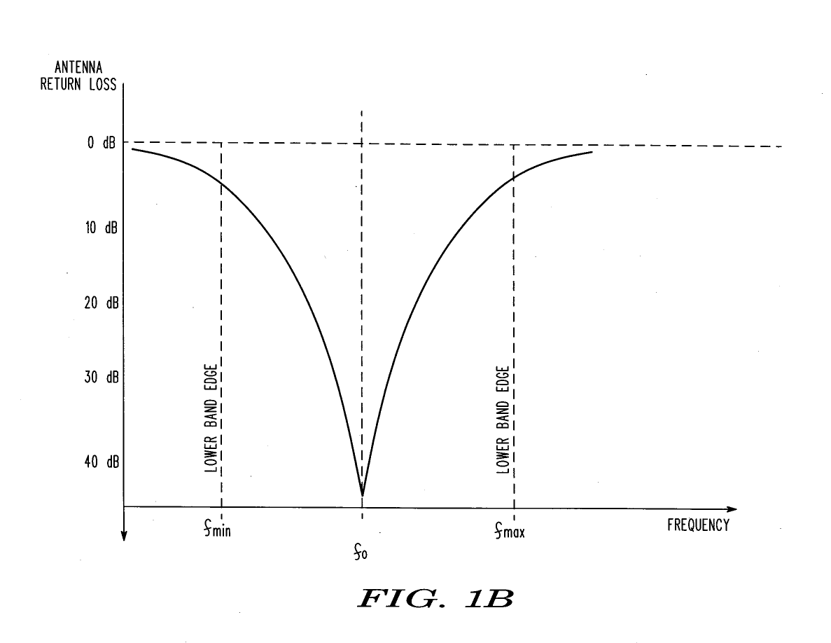

In addition, in each iteration of the blocks 410, 420, 430, and 440, the RFID reader generates the electromagnetic waves alternatively in two independent polarizations that are orthogonal to each other. Consequently, these electromagnetic waves are very similar to the electromagnetic waves generated by conventional RFID antennas operating in the cross-pole mode. However, when the frequency of the RF signal constantly hop within the allocated bandwidth fₘₐₓ-fₘᵢₙ, the effective return loss of the antenna 90 can be characterized by curve 380 as shown in FIG. 4C, which has statistically higher return losses than the return losses as shown in FIG. 1B for conventional RFID antennas operating in the cross-pole mode. Such improvement of return losses for the antenna 90 in an RFID reading system can increase the interrogation and operation range of the RFID reading system. Because of this improvement in reading efficiency, the battery run time of the RFID reading system can be improved as well.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. An antenna of an RFID reader for using within an allocated bandwidth of the RFID reader having a nominal center frequency comprising:
a first antenna structure for emitting and receiving electromagnetic waves primarily in a first polarization, the first antenna structure having a return loss maximized at a first optimal frequency;
a second antenna structure for emitting and receiving electromagnetic waves primarily in a second polarization that is orthogonal to the first polarization, the second antenna structure having a return loss maximized at a second optimal frequency; and
wherein the difference between the first optimal frequency and the second optimal frequency is more than 10% of the allocated bandwidth but less than 100% of the allocated bandwidth of the RFID reader.

2. The antenna of claim 1, further comprising:
a support member having thereon both the first antenna structure and the second antenna structure.

3. The antenna of claim 1, wherein the first antenna structure forms a dipole antenna, and the second antenna structure forms a dipole antenna.

4. The antenna of claim 1, wherein the first optimal frequency is lower than the nominal center frequency by a first offset that is more than 5% of the allocated bandwidth but less than 50% of the allocated bandwidth.

5. The antenna of claim 1, wherein the second optimal frequency is higher than the nominal center frequency by a second offset that is more than 5% of the allocated bandwidth but less than 50% of the allocated bandwidth.

6. The antenna of claim 1, wherein the nominal center frequency is approximately at the center frequency of the allocated bandwidth of the RFID reader.

7. The antenna of claim 1, wherein the nominal center frequency is different from the center frequency of the allocated bandwidth of the RFID reader.

8. A method of generating RF electromagnetic waves with an antenna of an RFID reader at frequencies in the vicinity of a nominal center frequency, the antenna comprising (1) a first antenna structure for emitting and receiving electromagnetic waves primarily in a first polarization; (2) a second antenna structure for emitting and receiving electromagnetic waves primarily in a second polarization that is orthogonal to the first polarization, and (3) wherein the first antenna structure has a return loss maximized at a first optimal frequency that is higher than the nominal center frequency and the second antenna structure has a return loss maximized at a second optimal frequency is lower than the nominal center frequency, the method comprising:
selecting a channel frequency from multiple channel frequencies within an allocated bandwidth;
comparing the selected channel frequency with the nominal center frequency; and
generating the electromagnetic waves with either the first antenna structure or the second antenna structure based upon the comparing, wherein the generating the electromagnetic waves comprises,
generating the electromagnetic waves with the first antenna structure when the selected channel frequency is higher than the nominal center frequency, and
generating the electromagnetic waves with the second antenna structure when the selected channel frequency is lower than the nominal center frequency.

9. The method of claim 8, comprising:
selecting consecutively a first channel frequency that is higher than the nominal center frequency and a second channel frequency that is lower than the nominal center frequency;
generating the electromagnetic waves at the first channel frequency with the first antenna structure; and
generating the electromagnetic waves at the second channel frequency with the second antenna structure.

10. The method of claim 8, wherein the first channel frequency and the second channel frequency are offset from the nominal center frequency by a same amount.

11. The method of claim 8, wherein the first antenna structure forms a dipole antenna, and the second antenna structure forms a dipole antenna.

12. The method of claim 8, wherein the antenna comprise a support member having thereon both the first antenna structure and the second antenna structure.

13. The method of claim 8, wherein the nominal center frequency is approximately at the center frequency of the allocated bandwidth of the RFID reader.

14. The method of claim 8, wherein the nominal center frequency is different from the center frequency of the allocated bandwidth of the RFID reader.

15. A method of generating electromagnetic waves by an RFDI reader using channel frequencies within an allocated bandwidth having a nominal center frequency comprising:
generating with a first antenna structure in the RFID reader electromagnetic waves primarily in a first polarization at channel frequencies higher than the nominal center frequency, the first antenna structure having a return loss maximized at a first optimal frequency that is higher than the nominal center frequency; and
generating with a second antenna structure in the RFID reader electromagnetic waves primarily in a second polarization at channel frequencies lower than the nominal center frequency, the second polarization being orthogonal to the first polarization, and the second antenna structure having a return loss maximized at a second optimal frequency that is lower than the nominal center frequency.
